(19) United States
(12) Patent Application Publication
(10) Pub. No.: US 2017/0123587 A1
(43) Pub. Date: May 4, 2017

(54) METHOD AND DEVICE FOR PREVENTING ACCIDENTAL TOUCH OF TERMINAL WITH TOUCH SCREEN

(71) Applicant: Xiaomi Inc., Beijing (CN)

(72) Inventors: Kun YANG, Beijing (CN); Shuangquan Pan, Beijing (CN); Jun Tao, Beijing (CN)

(73) Assignee: Xiaomi Inc., Beijing (CN)

(21) Appl. No.: 15/065,262

(22) Filed: Mar. 9, 2016

(30) Foreign Application Priority Data
Oct. 30, 2015 (CN) 201510729725.9

(51) Int. Cl. G06F 3/041; G06F 3/0488

(52) U.S. Cl. CPC G06F 3/0418; G06F 3/04883

(57) ABSTRACT

Aspects of the disclosure provide a method for preventing an accidental operation of a terminal device due to an accidental touch on a touch screen. The method includes detecting status information of the terminal device, detecting a touch gesture on the touch screen, determining, according to a pre-established relationship between status information of the terminal device and motion status information of touch gestures for touch behaviors, whether the status information of the terminal device and the touch gesture correspond to a same touch behavior, and when the status information of the terminal device and the touch gesture correspond to the same touch behavior, executing an operation associated with to the touch behavior.

### CROSS-REFERENCE TO RELATED APPLICATIONS

This application is filed based upon and claims priority to Chinese Patent Application No. 201510729725.9, filed on Oct. 30, 2015, the entire contents of which are incorporated herein by reference.

### TECHNICAL FIELD

The present disclosure generally relates to the field of terminals, and more particularly, to a method and device for preventing an accidental touch of a terminal with a touch screen.

### BACKGROUND

At present, many terminals, particularly intelligent terminals, are provided with touch screens. A user may complete operations through various touch operations on a touch screen, for example, an application may be started by a click operation on the touch screen. It brings great convenience to a user. However, it may lead to accidental operations, bringing the user with some unnecessary troubles.

### SUMMARY

Aspects of the disclosure provide a method for preventing an accidental operation of a terminal device due to an accidental touch on a touch screen. The method includes detecting status information of the terminal device, detecting a touch gesture on the touch screen, determining, according to a pre-established relationship between status information of the terminal device and motion status information of touch gestures for touch behaviors, whether the status information of the terminal device and the touch gesture correspond to a same touch behavior, and when the status information of the terminal device and the touch gesture correspond to the same touch behavior, executing an operation associated with to the touch behavior.

To determine, according to the pre-established relationship between status information of the terminal device and motion status information of touch gestures for the touch behaviors, whether the status information of the terminal device and the touch gesture correspond to the same touch behavior, in an example, the method includes determining whether a time difference between a first time when the status information of the terminal device is detected and a second time when the touch gesture is detected is equal to or smaller than a preset time difference, when the time difference is equal to or smaller than the preset time difference, determining whether the status information of the terminal device and the touch gesture correspond to the same touch behavior.

According to an aspect of the disclosure, the status information of the terminal device comprises at least one of: displacement information of the terminal device, and acceleration information of the terminal device. The motion status information of the touch gesture comprises at least one of: displacement information of the touch gesture, and acceleration information of the touch gesture.

In an example, the method includes detecting motion status information of a touch gesture corresponding to a specific touch behavior on the touch screen, and status information of the terminal device under the action of the touch gesture and establishing a corresponding relationship of the status information of the terminal device and the motion status information of the touch gesture to the specific touch behavior. Further, the method includes determining motion status information for the touch gesture corresponding to the status information of the terminal device according to the pre-established relationship, determining whether the determined motion status information of the touch gesture corresponding to the status information of the terminal device matches with the motion status information of the touch gesture, and determining that the status information of the terminal device and the touch gesture correspond to the same touch behavior when the determined motion status information matches the motion status of the touch gesture.

In an example, the status information of the terminal device corresponding to the same touch behavior includes an acceleration value of the terminal device in one direction is equal to or more than a first preset value. In another example, the status information of the terminal device corresponding to the same touch behavior includes the acceleration value of the terminal device in one direction is equal to or more than a second preset value and (an) acceleration value(s) in another direction or multiple other directions is/are equal to or smaller than a third preset values. For example, the method includes determining acceleration information of the terminal device according to the displacement information of the terminal device, and determining whether the status information and the touch gesture correspond to the same touch behavior according to the acceleration information of the terminal device and the pre-established relationship. In an example, the one direction comprises a direction perpendicular to a horizontal plane where the touch screen is located, or a direction parallel to the horizontal plane where the touch screen is located.

In an example, to detect the status information of the terminal device, the method includes receiving the status information of the terminal device from a chip arranged next to the touch screen and the chip being configured to detect motion status of the terminal device due to touch gestures on the touch screen.

Aspects of the disclosure provide a terminal device for preventing an accidental operation. The terminal device includes a touch screen, a processor and a memory configured to store executable instructions of the processor. The processor is configured to carry out the following operations: detect status information of the terminal device, detect a touch gesture on the touch screen; determine, according to a pre-established relationship for a touch behavior, whether the status information of the terminal device and the touch gesture correspond to the same touch behavior. The pre-established relationship is a relationship between status information of the terminal device and motion status information of touch gestures. When the status information of the terminal device and the touch gesture correspond to the same touch behavior, the process is configured to execute an operation corresponding to the touch behavior. In an example, the terminal device includes a chip arranged next to the touch screen and the chip being configured to detect motion status of the terminal due to touch gestures on the touch screen.

Aspects of the disclosure provide a non-transitory computer-readable storage medium having stored therein instructions that, when executed by a processor of a terminal device, causes the terminal device to perform operations for preventing an accidental operation due to an accidental touch on a touch screen. The operations include detecting status information of the terminal device, detecting a touch gesture on the touch screen, determining, according to a pre-established relationship for a touch behavior, whether the status information of the terminal device and the touch gesture correspond to the same touch behavior. The pre-established relationship is a relationship between status information of the terminal device and motion status information of touch gestures. Further, the operations include when the status information of the terminal device and the touch gesture correspond to the same touch behavior, executing an operation corresponding to the touch behavior.

It should be understood that the above general description and detailed description below are only exemplary and explanatory and not intended to limit the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart showing a method for preventing an accidental touch of a terminal with a touch screen, according to an exemplary embodiment.

FIG. 2 is a flow chart showing another method for preventing an accidental touch of a terminal with a touch screen, according to an exemplary embodiment.

FIG. 3 is a flow chart showing a third method for preventing an accidental touch of a terminal with a touch screen, according to an exemplary embodiment.

FIG. 4 is a flow chart showing a fourth method for preventing an accidental touch of a terminal with a touch screen, according to an exemplary embodiment.

FIG. 5 is a block diagram of a device for preventing an accidental touch of a terminal with a touch screen, according to an exemplary embodiment.

FIG. 6 is a block diagram of another device for preventing an accidental touch of a terminal with a touch screen, according to an exemplary embodiment.

FIG. 7 is a block diagram of a third device for preventing an accidental touch of a terminal with a touch screen, according to an exemplary embodiment.

FIG. 8 is a block diagram of a fourth device for preventing an accidental touch of a terminal with a touch screen, according to an exemplary embodiment.

FIG. 9 is a block diagram of a device for preventing an accidental touch of a terminal with a touch screen applicable to a terminal with a touch screen, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

At present, many terminals, particularly intelligent terminals, are provided with touch screens. A user may complete operations through various touch operations on a touch screen, for example, an application may be started by a click operation on the touch screen. It brings great convenience to a user. However, it may lead to accidental operations, bringing the user with some unnecessary troubles.

For solving this problem, the present disclosure provides a method for preventing an accidental touch of a terminal with a touch screen. The method is applicable to a terminal with a touch screen, and an execution entity corresponding to the method may be a terminal carried by a user. As shown in FIG. 1, the method includes Steps 101-103.

Step 101: detecting current status information of the terminal, and acquiring a current touch gesture which is acquired by a module configured to acquire a touch gesture, wherein the current status information of the terminal includes any one or more of posture information and motion status information of the terminal.

The posture information of the terminal may be information such as an inclination angle of a body of the terminal, and the posture information of the terminal may be acquired by a gyroscope.

The motion status information of the terminal may be displacement information of the terminal, acceleration information of the terminal, or a combination thereof. The module configured to acquire the touch gesture may be a touch screen or touch key which acquires the current touch gesture on the basis of capacitance detection, or a fingerprint module with a touch function.

Step 102: determining, according to a matching relationship pre-established for a touch behavior, whether the current status information of the terminal and the current touch gesture correspond to the same touch behavior, wherein the pre-established matching relationship is a relationship between status information of the terminal and motion status information of a touch gesture.

By Step 102, it may be determined whether the current touch gesture is effective, and whether the current touch gesture is an intended touch on the touch screen instead of an accidental touch. Specifically, when the current status information of the terminal and the current touch gesture correspond to the same touch behavior, it indicates that the current touch gesture is effective and the current touch gesture is an intended touch of a user on the touch screen instead of an accidental touch. On the contrary, when the current status information of the terminal and the current touch gesture do not correspond to the same touch behavior, it indicates that the current touch gesture is ineffective and should be an accidental touch, for example, it may be a gesture generated by an accidental touch on the touch screen due to unlocking of the screen when the user carries the terminal.

In addition, since the current status information of the terminal is generated by a touch gesture, a motion change may not be obvious. In order to avoid the phenomenon that the detected current status information of the terminal is not so accurate, a chip is additionally arranged in the terminal, the chip may be triggered by the touch gesture on the touch screen to move, and current status information of the chip may be deemed as the current status information of the terminal. Similarly, a matching relationship, pre-established for a touch behavior, between status information of the terminal and motion status information of a touch gesture may also be a matching relationship, pre-established for the touch behavior, between status information of the chip and motion status information of the touch gesture.

Moreover, the preset chip may be a chip where an acceleration sensor is located, the acceleration sensor may detect the status information of the chip where it is located. The chip is arranged below the touch screen in the terminal, and may move after receiving the touch gesture, thereby generating the current status information.

Step 103: when the current status information of the terminal and the current touch gesture correspond to the same touch behavior, executing an operation corresponding to the touch behavior.

When the detected current status information of the terminal and the current touch gesture do not correspond to the same touch behavior, it may be determined that there is an accidental touch, and a protection operation will be carried out. The determination may also be repeatedly for one or more times to recheck whether there is indeed an accidental touch, and a protection operation will be carried out when it is indeed an accidental touch. The protection operation may be locking the touch screen of the terminal, or forbidding starting of a preset program in the terminal within a preset time (for example, forbidding an outbound call, forbidding running of instant messaging software and forbidding running of a shopping application program) or controlling the terminal to enter a low-power-consumption mode, and the protection operation may further prevent the terminal from executing another accidental operation and improve an accidental touch prevention effect.

When the detected current status information of the terminal and the current touch gesture correspond to the same touch behavior, it indicates that the current touch gesture is effective, the probability that the current touch gesture is an accidental touch may be eliminated, and the operation corresponding to the touch behavior may be executed, thereby timely responding to the touch gesture of the user and ensuring good user experiences.

In addition, when the operation corresponding to the touch behavior is executed, the operation may be executed on the local terminal, and information about the touch behavior may also be sent to another terminal connected with the local terminal and the operation corresponding to the touch behavior is executed by the other terminal. For example, if the operation corresponding to the touch behavior is photographing with a photographing application program, the photographing application program may be started on the local terminal for photographing, or the information about the touch behavior may be sent to the other terminal connected with the local terminal and then the photographing application program is started on the other terminal for photographing.

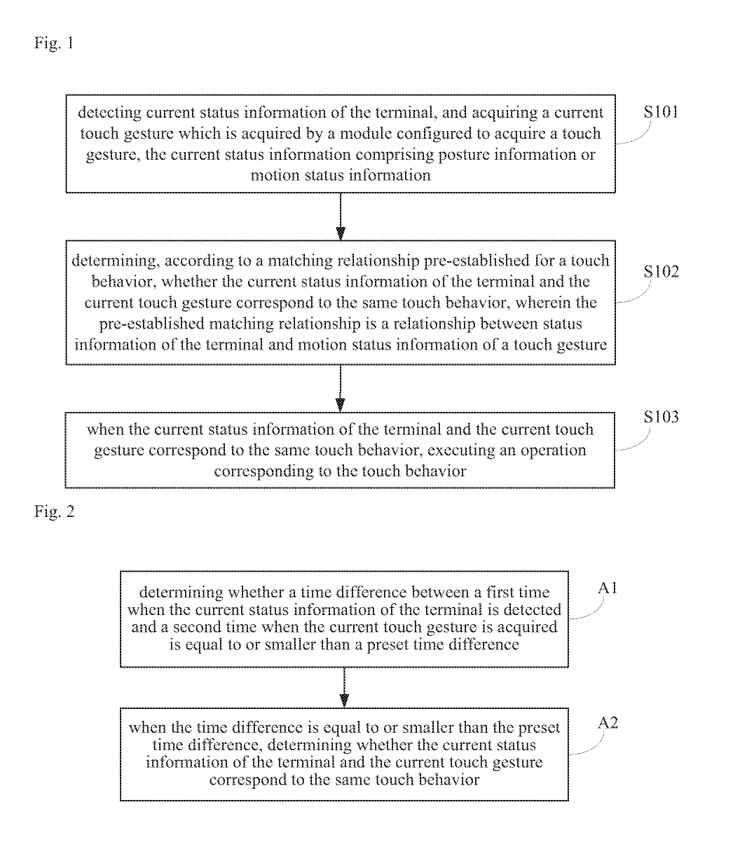

In one embodiment, Step 102, as shown in FIG. 2, may be executed by:

Step A1: determining whether a time difference between a first time when the current status information of the terminal is detected and a second time when the current touch gesture is acquired is equal to or smaller than a preset time difference; and

Step A2: when the time difference is equal to or smaller than the preset time difference, determining whether the current status information of the terminal and the current touch gesture correspond to the same touch behavior.

Due to the reasons of software and hardware, the first time and the second time may be different when a detection module detects the current status information of the terminal and the module configured to acquire the touch gesture acquires the current touch gesture. For preventing inaccuracy of a determination result about whether the current status information and the current touch gesture correspond to the same touch behavior, it is better not to determine whether the current status information of the terminal and the current touch gesture correspond to the touch behavior when the first time and the second time are acquired or only when the first time and the second time are the same. Instead, it may be determined whether the time difference between the first time and the second time is smaller than the preset time difference, and then it may be determined whether the current status information of the terminal and the current touch gesture correspond to the same touch behavior when the time difference is smaller than the preset time difference. In such a manner, the phenomenon that the determination result about whether the current status information and the current touch gesture correspond to the same touch behavior is ineffective because the time difference between the first time and the second time is excessively great may be prevented, and the phenomenon that the current status information of the terminal and the current touch gesture are incorrectly determined to be not corresponding to the same touch behavior because the first time is different from the second time for reasons of the software and the hardware may also be avoided.

In one embodiment, in the matching relationship, the motion status information of the terminal comprises at least one of: displacement information of the terminal, and acceleration information of the terminal, and the motion status information of the touch gesture comprises at least one of: displacement information of the touch gesture, and acceleration information of the touch gesture.

The motion status information of the terminal includes the displacement information of the terminal, such as a displacement direction and a displacement magnitude, and may further include the acceleration information, such as an acceleration direction and an acceleration magnitude, wherein the acceleration information may be determined by an acceleration sensor module or a gyroscope. Similarly, the motion status information of the touch gesture may include at least one of: the displacement information about displacement of the touch gesture on the touch screen, such as a displacement direction and a displacement magnitude, and sliding acceleration information, such as an acceleration direction and magnitude.

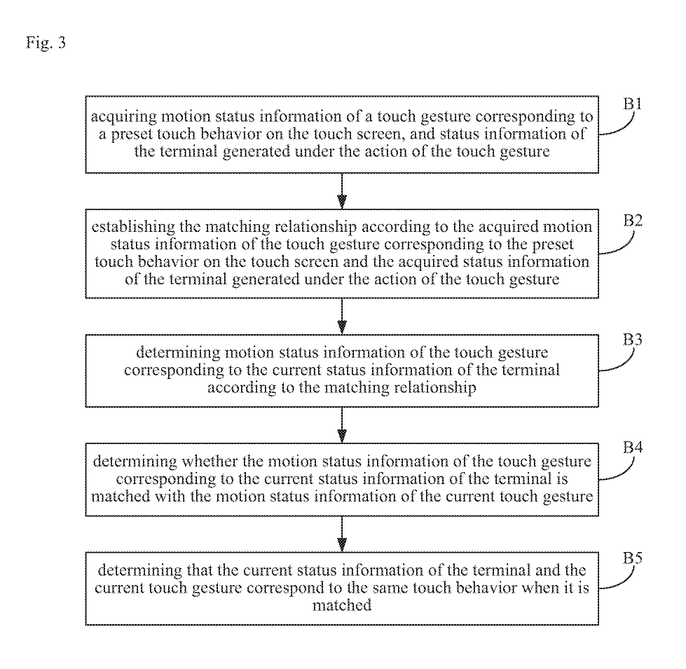

In one embodiment, Step 102, as shown in FIG. 3, may be executed by the following steps.

Step B1: acquiring motion status information of a touch gesture corresponding to a preset touch behavior on the touch screen, and status information of the terminal generated under the action of the touch gesture.

Step B2: establishing the matching relationship according to the acquired motion status information of the touch gesture corresponding to the preset touch behavior on the touch screen and the acquired status information of the terminal generated under the action of the touch gesture.

Each touch behavior corresponds to a touch gesture, and the touch gesture may not only have certain motion status information (i.e. the displacement magnitude and direction and acceleration magnitude and direction of a motion of the touch gesture relative to the touch screen when the user performs touch operation on the touch screen to generate the touch gesture) on the touch screen of the terminal, the terminal may also generate status information (i.e. an angle and displacement magnitude and direction and acceleration magnitude and direction of a motion of the terminal relative to a still reference such as the ground and a desktop) relative to the still reference such as the ground and the desktop, and the two motions correspond to each other, so that the matching relationship may be accurately established after the motion status information of the touch gesture corresponding to the preset touch behavior on the touch screen and the status information of the terminal generated under the action of the touch gesture are acquired.

Step B3: determining motion status information of the touch gesture corresponding to the current status information of the terminal according to the matching relationship.

After the current status information of the terminal is detected, the motion status information of the touch gesture corresponding to the current status information may be accurately according to the matching relationship.

Alternatively, status information of the terminal corresponding to the current motion status information of the touch gesture may also be determined according to the matching relationship.

Step B4: determining whether the motion status information of the touch gesture corresponding to the current status information of the terminal is matched with the motion status information of the current touch gesture.

Alternatively, it may also be determined whether the status information of the terminal corresponding to the current motion status information of the touch gesture is matched with the current status information of the terminal.

Step B5: determining that the current status information of the terminal and the current touch gesture correspond to the same touch behavior when it is matched.

Whether the current status information and the current touch gesture correspond to the same touch behavior may be accurately determined according to whether the motion status information of the touch gesture corresponding to the current status information of the terminal is matched with the acquired actual motion status information of the current touch gesture. Specifically, when the motion status information is matched with the actual motion status information, it indicates that the current touch gesture is the touch gesture corresponding to the current status information of the terminal, and it further indicates that the current touch gesture is effective and the current touch gesture and the current status information of the terminal correspond to the same touch behavior.

In one embodiment, the pre-established status information of the terminal corresponding to the same touch behavior may include: an acceleration variable of the terminal in one direction is equal to or more than a first preset variable; or the acceleration variable of the terminal in one direction is equal to or more than a second preset variable and (an) acceleration variable(s) in another direction or multiple other directions is/are equal to or smaller than a third preset variable. In the matching relationship, one direction is matched with a sliding gesture of the corresponding touch gesture, and for example, when the sliding gesture of the corresponding touch gesture is sliding in a direction A, an acceleration variable of the terminal in the direction A is required to be equal to or more than a variable, or an acceleration variable in a direction perpendicular to a horizontal plane where the touch screen is required to be equal to or more than a variable. In one embodiment, one direction may be the direction perpendicular to the horizontal plane where the touch screen is located, or a direction parallel to the horizontal plane where the touch screen is located. One direction may be the direction perpendicular to the horizontal plane where the touch screen is located, for example, an upward or downward direction perpendicular to the horizontal plane, or the direction parallel to the horizontal plane where the touch screen is located, for example, an upward, downward, leftward or rightward direction parallel to the horizontal plane.

For example, when the touch behavior is a screen unlocking behavior, the touch gesture corresponding to the screen unlocking behavior is vertical and downward double-click on the touch screen, motion status information of the vertical and downward double-click gesture includes a downward direction and acceleration magnitude of a millimeters/second of continuous two accelerations within a set time period. Correspondingly, status information, which is generated under the action of the vertical and downward double-click gesture, of the terminal includes a downward direction and acceleration magnitude of b millimeters/second of continuous two accelerations within the set time period; and a matching relationship may thus be established, and in the matching relationship: the motion status information of the vertical and downward double-click gesture includes the downward direction and acceleration magnitude of a millimeters/second of the continuous two accelerations within the set time period, and the status information of the terminal includes the downward direction and acceleration magnitude of b millimeters/second of the continuous two accelerations within the set time period.

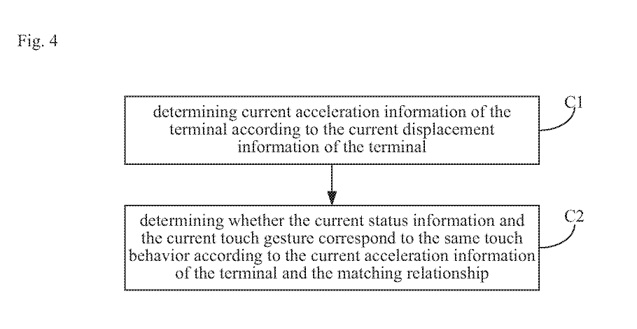

Corresponding to the abovementioned embodiment, in one embodiment, when the current status information of the terminal includes current displacement information of the terminal, Step 102, as shown in FIG. 4, may be executed by:

Step C1: determining current acceleration information of the terminal according to the current displacement information of the terminal; and

Step C2: determining whether the current status information and the current touch gesture correspond to the same touch behavior according to the current acceleration information of the terminal and the matching relationship.

The acceleration information may reflect a motion status of the terminal most directly. Therefore, when the status information is the displacement information of the terminal, the current acceleration information of the terminal may be determined according to the displacement information, and then it may be determined whether the current status information of the terminal and the current touch gesture correspond to the same touch behavior according to the current acceleration information and the pre-established matching relationship.

In another embodiment, when the terminal is handheld by the user, at least one finger of the user may touch the touch screen under a normal condition, and the body of the terminal may form a certain inclination angle with the horizontal plane. At this time, a matching relationship may be established according to experimental data, and in the matching relationship, the status information of the terminal includes: the inclination angle of the body of the terminal relative to the horizontal plane is within a preset angle range, and correspondingly, the motion status information of the corresponding touch gesture includes that a pressing duration of the touch screen reaches a preset time duration. If the current status information of the terminal and the motion status information of the current touch gesture are matched with the matching relationship, it indicates that the terminal is currently handheld by the user, and if the touch screen subsequently receives a touch gesture, operation may be performed according to the accidental touch prevention method provided by the present disclosure.

Corresponding to a method for preventing an accidental touch of a terminal with a touch screen, the present disclosure further provides a device for preventing an accidental touch of a terminal with a touch screen. As shown in FIG. 5, the device includes:

a processing module 501 configured to detect current status information of the terminal, and acquire a current touch gesture which is acquired by a module configured to acquire a touch gesture, the current status information including posture information or motion status information;

a determination module 502 configured to determine, according to a matching relationship pre-established for a touch behavior, whether the current status information of the terminal and the current touch gesture correspond to the same touch behavior, wherein the pre-established matching relationship is a relationship between status information of the terminal and motion status information of a touch gesture; and

an execution module 503 configured to, when the current status information of the terminal and the current touch gesture correspond to the same touch behavior, execute an operation corresponding to the touch behavior.

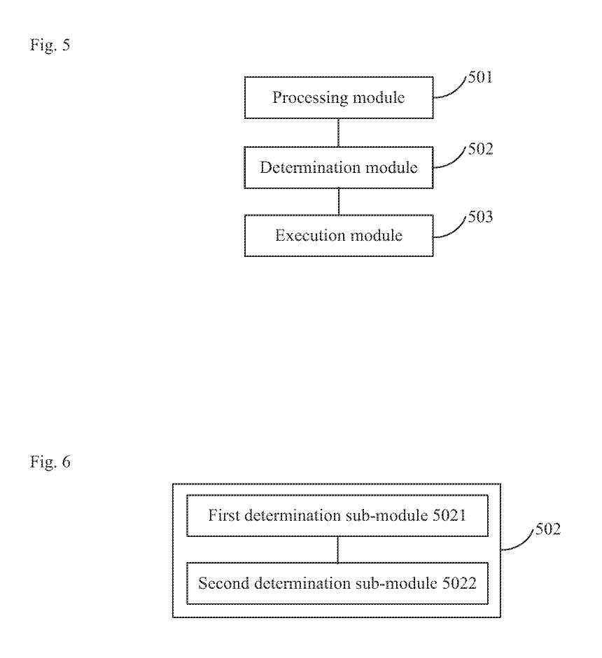

In one embodiment, the determination module 502, as shown in FIG. 6, includes:

a first determination sub-module 5021 configured to determine whether a time difference between a first time when the current status information of the terminal is detected and a second time when the current touch gesture is acquired is equal to or smaller than a preset time difference; and

a second determination sub-module 5022 configured to, when the time difference is equal to or smaller than the preset time difference, determine whether the current status information of the terminal and the current touch gesture correspond to the same touch behavior.

In one embodiment, the motion status information of the terminal comprises at least one of: displacement information of the terminal, and acceleration information of the terminal; and

the motion status information of the touch gesture comprises at least one of: displacement information of the touch gesture, and acceleration information of the touch gesture.

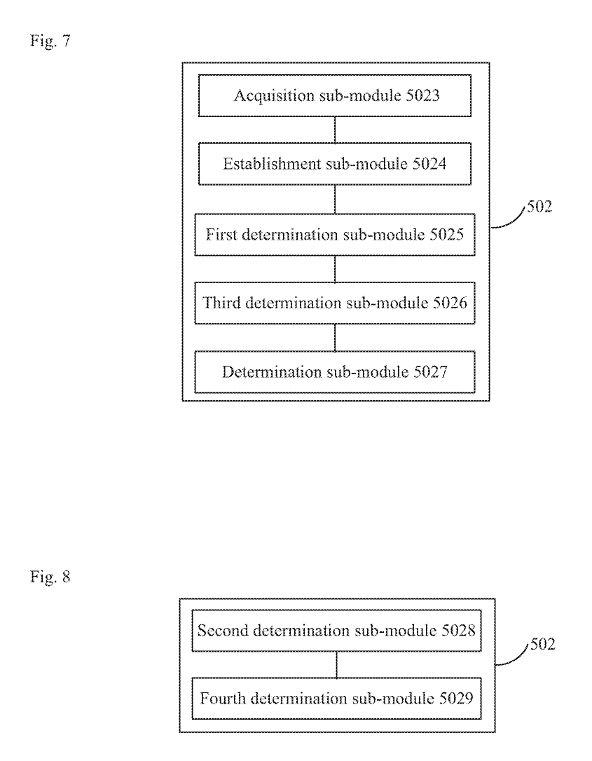

In one embodiment, the determination module 502, as shown in FIG. 7, includes:

an acquisition sub-module 5023, configured to acquire motion status information of a touch gesture corresponding to a preset touch behavior on the touch screen, and status information of the terminal generated under the action of the touch gesture;

an establishment sub-module 5024, configured to establish the matching relationship according to the acquired motion status information of the touch gesture corresponding to the preset touch behavior on the touch screen and the acquired status information of the terminal generated under the action of the touch gesture;

the determination module 502 further includes:

a first determination sub-module 5025, configured to determine motion status information of the touch gesture corresponding to the current status information of the terminal according to the matching relationship;

a third judgment sub-module 5026, configured to determine whether the motion status information of the touch gesture corresponding to the current status information of the terminal is matched with the motion status information of the current touch gesture; and

a determination sub-module 5027, configured to determine that the current status information of the terminal and the current touch gesture correspond to the same touch behavior when it is matched.

In one embodiment, the pre-established status information of the terminal corresponding to the same touch behavior includes:

an acceleration variable of the terminal in one direction is equal to or more than a first preset variable; or

the acceleration variable of the terminal in one direction is equal to or more than a second preset variable and (an) acceleration variable(s) in another direction or multiple other directions is/are equal to or smaller than a third preset variable.

In one embodiment, the determination module 502, as shown in FIG. 8, includes:

a second determination sub-module 5028, configured to determine current acceleration information of the terminal according to the current displacement information of the terminal; and

a fourth judgment sub-module 5029, configured to determine whether the current status information and the current touch gesture correspond to the same touch behavior according to the current acceleration information of the terminal and the matching relationship.

In one embodiment, said one direction includes a direction perpendicular to a horizontal plane where the touch screen is located, or a direction parallel to the horizontal plane where the touch screen is located.

According to a third aspect of the present disclosure, an accidental touch prevention device for a terminal with a touch screen is provided, which includes:

a processor: and

a memory configured to store executable instructions of the processor,

wherein the processor is configured to:

detect current status information of the terminal, and acquire a current touch gesture which is acquired by a module configured to acquire a touch gesture, the current status information including posture information or motion status information;

determine, according to a matching relationship pre-established for a touch behavior, whether the current status information of the terminal and the current touch gesture correspond to the same touch behavior, wherein the pre-established matching relationship is a relationship between status information of the terminal and motion status information of a touch gesture; and

when the current status information of the terminal and the current touch gesture correspond to the same touch behavior, execute an operation corresponding to the touch behavior.

The processor may be configured as follows:

the operation of determining whether the current status information of the terminal and the current touch gesture correspond to the same touch behavior includes:

determining whether a time difference between a first time when the current status information of the terminal is detected and a second time when the current touch gesture is acquired is equal to or smaller than a preset time difference; and

when the time difference is equal to or smaller than the preset time difference, determining whether the current status information of the terminal and the current touch gesture correspond to the same touch behavior.

The processor may be configured as follows:

the motion status information of the terminal comprises at least one of: displacement information of the terminal, and acceleration information of the terminal; and

the motion status information of the touch gesture comprises at least one of: displacement information of the touch gesture, and acceleration information of the touch gesture.

The processor may be configured as follows:

pre-establishing, for a touch behavior, a matching relationship between status information of the terminal and motion status information of a touch gesture may specifically include:

acquiring motion status information of a touch gesture corresponding to a preset touch behavior on the touch screen, and status information of the terminal generated under the action of the touch gesture;

establishing the matching relationship according to the acquired motion status information of the touch gesture corresponding to the preset touch behavior on the touch screen and the acquired status information of the terminal generated under the action of the touch gesture;

the operation of determining, according to a matching relationship pre-established for a touch behavior, whether the current status information of the terminal and the current touch gesture correspond to the same touch behavior includes:

determining motion status information of the touch gesture corresponding to the current status information of the terminal according to the matching relationship:

determining whether the motion status information of the touch gesture corresponding to the current status information of the terminal is matched with the motion status information of the current touch gesture; and

determining that the current status information of the terminal and the current touch gesture correspond to the same touch behavior when it is matched.

The processor may be configured as follows:

the pre-established status information of the terminal corresponding to the same touch behavior comprises:

an acceleration variable of the terminal in one direction is equal to or more than a first preset variable; or

the acceleration variable of the terminal in one direction is equal to or more than a second preset variable and (an) acceleration variable(s) in another direction or multiple other directions is/are equal to or smaller than a third preset variable.

The processor may be configured as follows:

when the current status information of the terminal comprises current displacement information of the terminal, the operation of determining whether the current status information of the terminal and the current touch gesture correspond to the same touch behavior according to the pre-established matching relationship includes:

determining current acceleration information of the terminal according to the current displacement information of the terminal; and

determining whether the current status information and the current touch gesture correspond to the same touch behavior according to the current acceleration information of the terminal and the matching relationship.

The processor may be configured as follows:

Said one direction includes a direction perpendicular to a horizontal plane where the touch screen is located, or a direction parallel to the horizontal plane where the touch screen is located.

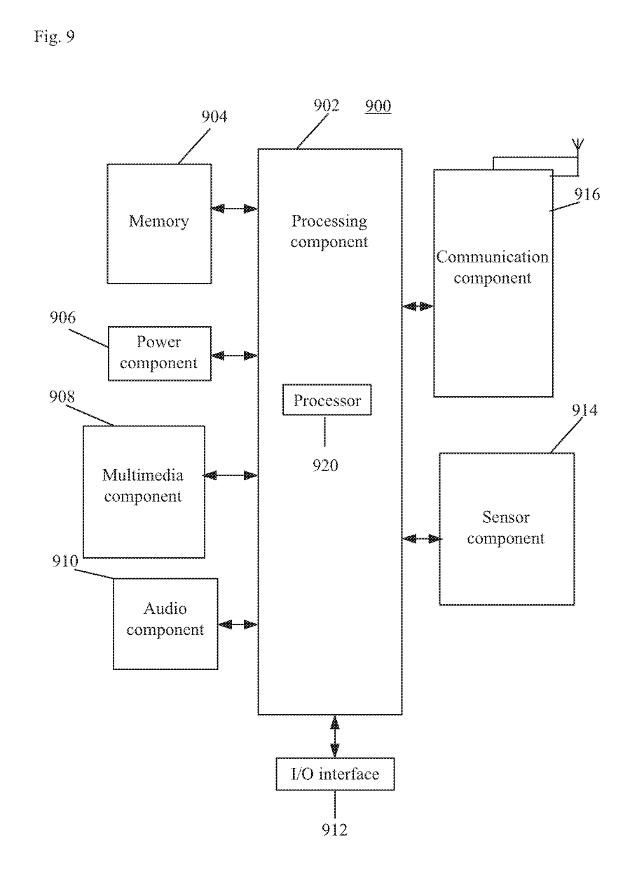

FIG. 9 is a block diagram of an accidental touch prevention device 900 for a terminal with a touch screen, according to an exemplary embodiment. The device is applicable to terminal equipment. For example, the device 900 may be a mobile phone, a computer, a digital broadcast terminal, a messaging device, a gaming console, a tablet, a medical device, exercise equipment, a personal digital assistant and the like.

Referring to FIG. 9, the device 900 may include one or at least two of the following components: a processing component 902, a memory 904, a power component 906, a multimedia component 908, an audio component 910, an Input/Output (I/O) interface 912, a sensor component 914, and a communication component 916.

The processing component 902 typically controls overall operations of the device 900, such as the operations associated with display, telephone calls, data communications, camera operations, and recording operations. The processing component 902 may include one or at least two processors 920 to execute instructions to perform all or part of the steps in the abovementioned methods. Moreover, the processing component 902 may include one or at least two modules which facilitate interaction between the processing component 902 and the other components. For instance, the processing component 902 may include a multimedia module to facilitate interaction between the multimedia component 908 and the processing component 902.

The memory 904 is configured to store various types of data to support the operation of the device 900. Examples of such data include instructions for any storage objects or methods operated on the device 900, contact data, phonebook data, messages, pictures, video, etc. The memory 904 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power component 906 provides power for various components of the device 900. The power component 906 may include a power management system, one or at least two power supplies, and other components associated with the generation, management and distribution of power for the device 900.

The multimedia component 908 includes a screen providing an output interface between the device 900 and the user. In some embodiments, the screen may include a Liquid Crystal Display (LCD) and a Touch Panel (TP). If the screen includes the TP, the screen may be implemented as a touch screen to receive an input signal from the user. The TP includes one or at least two touch sensors to sense touches, swipes and gestures on the TP. The touch sensors may not only sense a boundary of a touch or swipe action, but also sense a duration and pressure associated with the touch or swipe action. In some embodiments, the multimedia component 908 includes a front camera and/or a rear camera. The front camera and/or the rear camera may receive external multimedia data when the device 900 is in an operation mode, such as a photographing mode or a video mode. Each of the front camera and the rear camera may be a fixed optical lens system or have focusing and optical zooming capabilities.

The audio component 910 is configured to output and/or input an audio signal. For example, the audio component 910 includes a microphone (MIC), and the MIC is configured to receive an external audio signal when the device 900 is in the operation mode, such as a call mode, a recording mode and a voice recognition mode. The received audio signal may be further stored in the memory 904 or sent through the communication component 916. In some embodiments, the audio component 910 further includes a speaker configured to output the audio signal.

The I/O interface 912 provides an interface between the processing component 902 and a peripheral interface module, and the peripheral interface module may be a keyboard, a click wheel, a button and the like. The button may include, but not limited to: a home button, a volume button, a starting button and a locking button.

The sensor component 914 includes one or at least two sensors configured to provide status assessment in various aspects for the device 900. For instance, the sensor component 914 may detect an on/off status of the device 900 and relative positioning of components, such as a display and small keyboard of the device 900, and the sensor component 914 may further detect a change in a position of the device 900 or a component of the device 900, presence or absence of contact between the user and the device 900, orientation or acceleration/deceleration of the device 900 and a change in temperature of the device 900. The sensor component 914 may include a proximity sensor configured to detect presence of an object nearby without any physical contact. The sensor component 914 may also include a light sensor, such as a Complementary Metal Oxide Semiconductor (CMOS) or Charge Coupled Device (CCD) image sensor, configured for use in an imaging application. In some embodiments, the sensor component 914 may also include an acceleration sensor, a gyroscope sensor, a magnetic sensor, a pressure sensor or a temperature sensor.

The communication component 916 is configured to facilitate wired or wireless communication between the device 900 and another device. The device 900 may access a communication-standard-based wireless network, such as a Wireless Fidelity (WiFi) network, a 2nd-Generation (2G) or 3rd-Generation (3G) network or a combination thereof. In an exemplary embodiment, the communication component 916 receives a broadcast signal or broadcast associated information from an external broadcast management system through a broadcast channel. In an exemplary embodiment, the communication component 916 further includes a Near Field Communication (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a BlueTooth (BT) technology and another technology.

In the exemplary embodiment, the device 900 may be implemented by one or at least two Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned methods.

In the exemplary embodiment, there is also provided a non-transitory computer-readable storage medium including an instruction, such as the memory 904 including an instruction, and the instruction may be executed by the processor 920 of the device 900 to implement the abovementioned methods. For example, the non-transitory computer-readable storage medium may be a ROM, a Random Access Memory (RAM), a Compact Disc Read-Only Memory (CD-ROM), a magnetic tape, a floppy disc, an optical data storage device and the like.

According to the non-transitory computer-readable storage medium, when the instruction in the storage medium is executed by the processor of the device 900, the device 900 may execute a method for preventing an accidental touch of a terminal with a touch screen, including the following steps:

detecting current status information of the terminal, and acquiring a current touch gesture which is acquired by a module configured to acquire a touch gesture, the current status information comprising posture information or motion status information;

determining, according to a matching relationship pre-established for a touch behavior, whether the current status information of the terminal and the current touch gesture correspond to the same touch behavior, wherein the pre-established matching relationship is a relationship between status information of the terminal and motion status information of a touch gesture; and

when the current status information of the terminal and the current touch gesture correspond to the same touch behavior, executing an operation corresponding to the touch behavior.

In one embodiment, the step of determining whether the current status information of the terminal and the current touch gesture correspond to the same touch behavior includes:

determining whether a time difference between a first time when the current status information of the terminal is detected and a second time when the current touch gesture is acquired is equal to or smaller than a preset time difference; and

when the time difference is equal to or smaller than the preset time difference, determining whether the current status information of the terminal and the current touch gesture correspond to the same touch behavior.

In one embodiment, the motion status information of the terminal comprises at least one of: displacement information of the terminal, and acceleration information of the terminal; and

the motion status information of the touch gesture comprises at least one of: displacement information of the touch gesture, and acceleration information of the touch gesture.

In one embodiment, pre-establishing, for a touch behavior, a matching relationship between status information of the terminal and motion status information of a touch gesture specifically includes:

acquiring motion status information of a touch gesture corresponding to a preset touch behavior on the touch screen, and status information of the terminal generated under the action of the touch gesture;

establishing the matching relationship according to the acquired motion status information of the touch gesture corresponding to the preset touch behavior on the touch screen and the acquired status information of the terminal generated under the action of the touch gesture;

the step of determining, according to a matching relationship pre-established for a touch behavior, whether the current status information of the terminal and the current touch gesture correspond to the same touch behavior includes:

determining motion status information of the touch gesture corresponding to the current status information of the terminal according to the matching relationship;

determining whether the motion status information of the touch gesture corresponding to the current status information of the terminal is matched with the motion status information of the current touch gesture; and

determining that the current status information of the terminal and the current touch gesture correspond to the same touch behavior when it is matched.

In one embodiment, the pre-established status information of the terminal corresponding to the same touch behavior includes:

an acceleration variable of the terminal in one direction is equal to or more than a first preset variable; or

the acceleration variable of the terminal in one direction is equal to or more than a second preset variable and (an) acceleration variable(s) in another direction or multiple other directions is/are equal to or smaller than a third preset variable.

In one embodiment, when the current status information of the terminal comprises current displacement information of the terminal, the step of determining whether the current status information of the terminal and the current touch gesture correspond to the same touch behavior according to the pre-established matching relationship includes:

determining current acceleration information of the terminal according to the current displacement information of the terminal: and

determining whether the current status information and the current touch gesture correspond to the same touch behavior according to the current acceleration information of the terminal and the matching relationship.

In one embodiment, said one direction includes a direction perpendicular to a horizontal plane where the touch screen is located, or a direction parallel to the horizontal plane where the touch screen is located.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

### INDUSTRIAL APPLICABILITY

In the technical solutions provided by the present disclosure, according to a matching relationship pre-established for a touch behavior, wherein the pre-established matching relationship is a relationship between status information of the terminal and motion status information of a touch gesture, it may be determined whether the current status information of the terminal and the current touch gesture correspond to the same touch behavior, and it thus may be determined whether the touch gesture is effective. When the touch gesture is effective, an operation corresponding to the touch behavior will be carried out, thereby ensuring perfect user experiences.

What is claimed is:

1. A method for preventing an accidental operation of a terminal device due to an accidental touch on a touch screen, comprising:
detecting status information of the terminal device;
detecting a touch gesture on the touch screen;
determining, according to a pre-established relationship between status information of the terminal device and motion status information of touch gestures for touch behaviors, whether the status information of the terminal device and the touch gesture correspond to a same touch behavior; and
when the status information of the terminal device and the touch gesture correspond to the same touch behavior, executing an operation associated with to the touch behavior.

2. The method according to claim 1, wherein determining, according to the pre-established relationship between status information of the terminal device and motion status information of touch gestures for the touch behaviors, whether the status information of the terminal device and the touch gesture correspond to the same touch behavior comprises:
determining whether a time difference between a first time when the status information of the terminal device is detected and a second time when the touch gesture is detected is equal to or smaller than a preset time difference; and
when the time difference is equal to or smaller than the preset time difference, determining whether the status information of the terminal device and the touch gesture correspond to the same touch behavior.

3. The method according to claim 1, wherein
the status information of the terminal device comprises at least one of: displacement information of the terminal device, and acceleration information of the terminal device; and
the motion status information of the touch gesture comprises at least one of: displacement information of the touch gesture, and acceleration information of the touch gesture.

4. The method according to claim 1, further comprising:
detecting motion status information of a touch gesture corresponding to a specific touch behavior on the touch screen, and status information of the terminal device under the action of the touch gesture; and
establishing a corresponding relationship of the status information of the terminal device and the motion status information of the touch gesture to the specific touch behavior.

5. The method according to claim 1, wherein determining, according to the pre-established relationship between the status information of the terminal device and the motion status information of touch gestures for touch behaviors, whether the status information of the terminal device and the touch gesture correspond to the same touch behavior further comprises:
determining motion status information for the touch gesture corresponding to the status information of the terminal device according to the pre-established relationship;
determining whether the determined motion status information of the touch gesture corresponding to the status information of the terminal device matches with the motion status information of the touch gesture; and
determining that the status information of the terminal device and the touch gesture correspond to the same touch behavior when the determined motion status information matches the motion status of the touch gesture.

6. The method according to claim 1, wherein
the status information of the terminal device corresponding to the same touch behavior comprises:
an acceleration value of the terminal device in one direction is equal to or more than a first preset value; or
the acceleration value of the terminal device in one direction is equal to or more than a second preset value and (an) acceleration value(s) in another direction or multiple other directions is/are equal to or smaller than a third preset values.

7. The method according to claim 6, wherein the status information of the terminal device comprises displacement information of the terminal device, and the step of determining whether the c status information of the terminal device and the touch gesture correspond to the same touch behavior according to the pre-established relationship comprises:
determining acceleration information of the terminal device according to the displacement information of the terminal device; and
determining whether the status information and the touch gesture correspond to the same touch behavior according to the acceleration information of the terminal device and the pre-established relationship.

8. The method according to claim 6, wherein
said one direction comprises a direction perpendicular to a horizontal plane where the touch screen is located, or a direction parallel to the horizontal plane where the touch screen is located.

9. The method of claim 1, wherein detecting the status information of the terminal device further comprises:
receiving the status information of the terminal device from a chip arranged next to the touch screen and the chip being configured to detect motion status of the terminal device due to touch gestures on the touch screen.

10. A terminal device for preventing an accidental operation, comprising:
a touch screen;
a processor, and
a memory configured to store executable instructions of the processor,
wherein the processor is configured to carry out the following operations:
detect status information of the terminal device;
detect a touch gesture on the touch screen;
determine, according to a pre-established relationship for a touch behavior, whether the status information of the terminal device and the touch gesture correspond to the same touch behavior, wherein the pre-established relationship is a relationship between status information of the terminal device and motion status information of touch gestures; and
when the status information of the terminal device and the touch gesture correspond to the same touch behavior, execute an operation corresponding to the touch behavior.

11. The terminal device according to claim 10, wherein the operation of determining whether the status information of the terminal device and the touch gesture correspond to the same touch behavior comprises:
determining whether a time difference between a first time when the status information of the terminal device is detected and a second time when the touch gesture is detected is equal to or smaller than a preset time difference; and
when the time difference is equal to or smaller than the preset time difference, determining whether the status information of the terminal device and the touch gesture correspond to the same touch behavior.

12. The terminal device according to claim 10, wherein
the status information of the terminal device comprises at least one of: displacement information of the terminal device, and acceleration information of the terminal device; and
the motion status information of the touch gesture comprises at least one of: displacement information of the touch gesture, and acceleration information of the touch gesture.

13. The terminal device according to claim 10, wherein the processor is configured to detect motion status information of a touch gesture corresponding to a specific touch behavior on the touch screen, and status information of the terminal device under the action of the touch gesture, and establish a corresponding relationship of the status information of the terminal device and the motion status information of the touch gesture to the specific touch behavior.

14. The terminal device according to claim 10, wherein
the status information of the terminal device corresponding to the same touch behavior comprises:
an acceleration value of the terminal device in one direction is equal to or more than a first preset value; or
the acceleration value of the terminal device in one direction is equal to or more than a second preset value and (an) acceleration variable(s) in another direction or multiple other directions is/are equal to or smaller than a third preset value.

15. The terminal device according to claim 14, wherein the status information of the terminal device comprises displacement information of the terminal device, the processor is configured to
determine acceleration information of the terminal device according to the current displacement information of the terminal device; and
determine whether the status information and the touch gesture correspond to the same touch behavior according to the acceleration information of the terminal device and the pre-established relationship.

16. The terminal device according to claim 14, wherein
said one direction comprises a direction perpendicular to a horizontal plane where the touch screen is located, or a direction parallel to the horizontal plane where the touch screen is located.

17. The terminal device of claim 10, further comprising:
a chip arranged next to the touch screen and the chip being configured to detect motion status of the terminal device due to touch gestures on the touch screen.

18. A non-transitory computer-readable storage medium having stored therein instructions that, when executed by a processor of a terminal device, causes the terminal device to perform operations for preventing an accidental operation due to an accidental touch on a touch screen, the operations comprising:
detecting status information of the terminal device;
detecting a touch gesture on the touch screen;
determining, according to a pre-established relationship for a touch behavior, whether the status information of the terminal device and the touch gesture correspond to the same touch behavior, wherein the pre-established relationship is a relationship between status information of the terminal device and motion status information of touch gestures; and
when the status information of the terminal device and the touch gesture correspond to the same touch behavior, executing an operation corresponding to the touch behavior.

19. The non-transitory computer-readable storage medium according to claim 18, wherein the operations of determining whether the status information of the terminal device and the touch gesture correspond to the same touch behavior comprise:
determining whether a time difference between a first time when the status information of the terminal device is detected and a second time when the touch gesture is detected is equal to or smaller than a preset time difference; and
when the time difference is equal to or smaller than the preset time difference, determining whether the status information of the terminal device and the touch gesture correspond to the same touch behavior.

20. The non-transitory computer-readable storage medium according to claim 18, wherein
the motion status information of the terminal device comprises at least one of: displacement information of the terminal device, and acceleration information of the terminal device; and
the motion status information of the touch gesture comprises at least one of: displacement information of the touch gesture, and acceleration information of the touch gesture.
